(19) United States
(12) Patent Application Publication
(10) Pub. No.: US 2019/0060947 A1
(43) Pub. Date: Feb. 28, 2019

(54) COATING DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Weipeng CAO, Beijing (CN); Shichao MA, Beijing (CN); Chao XUE, Beijing (CN)

(21) Appl. No.: 15/989,336

(22) Filed: May 25, 2018

(30) Foreign Application Priority Data
Aug. 31, 2017 (CN) 201710770753.4

(51) Int. Cl. B05C 5/00; B05C 21/00; B05C 9/14; B05C 13/00; B08B 1/00; B08B 3/02; B08B 3/08

(52) U.S. Cl. CPC B05C 5/002; B05C 21/00; B05C 9/14; B08B 3/08; B08B 1/005; B08B 3/02; B05C 13/00

(57) ABSTRACT

A coating device includes: a coating component for coating a workpiece, wherein the coating component has an accelerated motion stage and a uniform motion stage, wherein an initial coating region of the coating device corresponds to the accelerated motion stage, and wherein a uniform coating region of the coating device corresponds to the uniform motion stage; a primary machine used for bearing the workpiece, wherein the bearing surface of the primary machine is located in the uniform coating region of the coating device; and a secondary machine for assisting in coating, wherein the bearing surface of the secondary machine is located in the initial coating region of the coating device. The coating device can make the coating component reach a uniform speed before is coating the workpiece, thus fundamentally eliminating the problem of poor initial coating.

### RELATED APPLICATION

This application claims the priority of a Chinese patent application No. 201710770753.4 filed on Aug. 31, 2017, the entire content of which is incorporated herein by reference.

### FIELD OF THE DISCLOSURE

The present disclosure relates to the technical field of coating, and more particularly, to a coating device.

### BACKGROUND OF THE DISCLOSURE

In the manufacturing process of color films (color filters), the use of coating machines is very common. Glue coating devices are also very important. At the initial stage of glue coating in a coating machine, a coating component usually goes through a process from acceleration to uniform speed, and the initial coating region of this acceleration is about 5 cm. If the glue coating in the initial coating region is not good, it will have adverse effects on the subsequent process and affect the product quality. The coating machine often has the problem of poor initial coating, which affects the final product quality.

### SUMMARY OF THE DISCLOSURE

In view of this, embodiments of the present disclosure provide a coating device comprising a coating component for coating a workpiece to be coated, wherein the coating component has an accelerated motion stage and a uniform motion stage in the running process, and wherein an initial coating region of the coating device corresponds to the accelerated motion stage, and wherein a uniform coating region of the coating device corresponds to the uniform motion stage; a primary machine, used for bearing the workpiece to be coated, wherein the bearing surface of the primary machine is located in the uniform coating region of the coating device; and a secondary machine for assisting coating, wherein the bearing surface of the secondary machine is located in the initial coating region of the coating device.

According to an embodiment of the present disclosure, the secondary machine is configured as a turntable which can rotate around a rotation axis extending in a horizontal direction, and at least a part of the outer peripheral surface of the turntable forms the bearing surface of the secondary machine.

According to an embodiment of the present disclosure, the secondary machine is movable relative to the primary machine.

According to an embodiment of the present disclosure, the secondary machine comprises a cleaning mechanism for cleaning the bearing surface of the secondary machine.

According to an embodiment of the present disclosure, the cleaning mechanism comprises: a liquid spraying unit for spraying diluent to the bearing surface of the secondary machine; a scraping unit for cleaning the bearing surface of the secondary machine by scraping, wherein the scraping unit is arranged on the downstream side of the liquid spraying unit along the rotating direction of the turntable or is integrated with the liquid spraying unit.

According to an embodiment of the present disclosure, the cleaning mechanism further comprises: a wiping unit arranged on the downstream side of the scraping unit along the rotation direction of the turntable and in contact with the bearing surface of the secondary machine to further clean the bearing surface of the secondary machine by wiping.

According to an embodiment of the present disclosure, the cleaning mechanism further comprises: a hot air unit for cleaning the bearing surface of the secondary machine, wherein the hot air unit is arranged on the downstream side of the wiping unit along the rotating direction of the turntable, and further cleans the bearing surface by blowing air.

According to an embodiment of the present disclosure, one end of the bearing surface of the secondary machine adjacent to the primary machine is provided with a recess.

According to an embodiment of the present disclosure, the vertical cross section of the recess is formed into a rectangle.

According to an embodiment of the present disclosure, the secondary machine further comprises: a secondary machine driving portion for driving the secondary machine to rotate and/or move relative to the primary machine.

According to an embodiment of the present disclosure, a longitudinal cross section of the turntable perpendicular to its rotation axis is shaped as an elliptical, and the liquid spraying unit, the wiping unit and the hot air unit are sequentially arranged below the turntable along the rotation direction of the turntable.

According to an embodiment of the present disclosure, the secondary machine further comprises: a heating unit for heating the bearing surface of the secondary machine.

According to an embodiment of the present disclosure, the heating temperature of the heating unit is 40° C. to 60° C.

According to an embodiment of the present disclosure, the movement direction of the secondary machine relative to the primary machine is parallel to the axial direction of the rotation axis of the secondary machine.

According to an embodiment of the present disclosure, when the secondary machine rotates, the conveying direction of the bearing surface of the secondary machine is perpendicular to the coating direction of the coating component.

According to an embodiment of the present disclosure, the coating direction of the coating component is parallel to the axial direction of the rotation axis of the secondary machine.

According to an embodiment of the present disclosure, one end of the workpiece to be coated near the secondary machine is borne on the upper surface of the recess.

According to an embodiment of the present disclosure, the width of the bearing surface of the secondary machine extending in a direction parallel to the axial direction of its rotation axis is about 5 cm.

Additional embodiments and advantages of this disclosure will be given in part in the following description, and in part will be obvious from the following description or will be learned by the practice of this disclosure.

### BRIEF DESCRIPTION OF THE DRAWINGS

The above and/or additional embodiments and advantages of the present disclosure will become apparent and easy to understand from the description of embodiments in conjunction with the following drawings, in which:

FIG. 1 is a top view of a coating device according to an embodiment of the present disclosure;

FIG. 2 is a left view of the coating device according to the embodiment of the present disclosure;

FIG. 3 is a front view of the coating device according to the embodiment of the present disclosure;

FIG. 4 is a partially enlarged structural schematic view at block A in FIG. 2.

### DETAILED DESCRIPTION OF THE DISCLOSURE

Embodiments of the present disclosure are described in detail below, examples of which are shown in the accompanying drawings. The embodiments described below with reference to the drawings are exemplary and are intended to be used to explain this disclosure but should not be construed as limitations to this disclosure. Those skilled in the art can make various changes, modifications, substitutions and variations to these embodiments without departing from the principles and purposes of this disclosure, and the scope of this disclosure is defined by the claims and their equivalents.

In the description of the present disclosure, it is to be understood that the orientational or positional relationship indicated by the terms “length”, “width”, “thickness”, “upper”, “lower”, “front”, “rear”, “left”, “right”, “top”, “bottom”, “inner”, “outer”, “axial”, “radial”, “circumferential” and the like is based on the orientational or positional relationship shown in the accompanying drawings, only for convenience in describing the present disclosure and simplifying the description, and not to indicate or imply that the device or element referred to must have a specific orientation, be constructed and operated in a specific orientation, so it is not to be understood as a limitation to the present disclosure. In addition, the features defined as “first ” and “second” may explicitly or implicitly include one or more of the features. In the description of this disclosure, unless otherwise indicated, the meaning of “plurality” is two or more.

The general inventive concept of this application is as follows: because the initial coating region of the traditional coating machine overlaps with the panel area where the workpiece to be coated is placed, and the coating component is still in an accelerating state rather than a uniform speed state when just entering the area above the panel area, it is easy to lead to poor coating of a part of the panel area that overlaps with the initial coating region. At present, the main solution to poor coating on the initial part of the panel is generally to shorten the initial coating region of the coating machine by adjusting the coating procedure, but this solution can't completely make the coating component at a uniform speed state when entering the panel area and can't fundamentally solve the problem of poor initial part. In view of this, an embodiment of the present disclosure provides a coating device, which can make the coating component reach a uniform speed before coating the workpiece to be coated, fundamentally eliminating the problem of poor initial part of the coating machine, greatly reducing the times of line stopping maintenance, not only saving the labor cost, but also saving the cost of consumables such as clean cloth, rubber gloves and the like used for maintenance, improving the productivity and product quality, reducing the breakage of the workpiece to be coated and avoiding quality accidents.

The coating device 110 according to an embodiment of the present disclosure will be described in detail below with reference to the drawings.

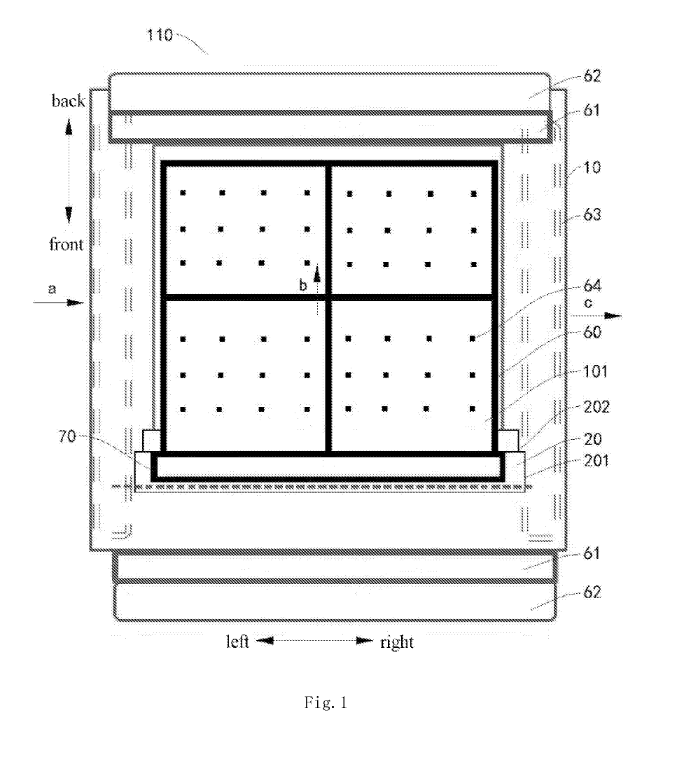

Referring to FIGS. 1-4, the coating device 110 according to the embodiment of the present disclosure includes: a coating component 62 for coating a workpiece 60 to be coated, wherein the coating component 62 has an accelerated motion stage and a uniform motion stage during running process, an initial coating region of the coating device 110 corresponds to the accelerated motion stage, and a uniform coating region of the coating device corresponds to the uniform motion stage; a primary machine 10 and a secondary machine 20.

Specifically, the position of a bearing surface of the primary machine 10 corresponds to the uniform coating region of the coating device 110 and is used to bear a workpiece 60 to be coated. The secondary machine 20 is used to assist in coating, and the position of a bearing surface of the secondary machine 20 corresponds to the initial coating region 70 of the coating device 110. The workpiece 60 to be coated may be, for example, a glass substrate or other workpieces that need to be coated with glue.

Because the coating component (e.g., nozzle) 62 of the coating device 110 has a process of accelerating to a uniform speed when coating is started, correspondingly, the coating region of the coating device 110 includes an initial coating region 70 and a uniform coating region, and the initial coating region 70 can correspond to the accelerated motion stage of the coating component 62 in the coating process, and the uniform coating region can correspond to the uniform motion stage of the coating component 62. In the traditional coating device, a part of the initial coating region will be located in a panel area where the workpiece to be coated is placed (that is, a part of the initial coating region overlaps with the area where the workpiece 60 to be coated is located), thus causing the coating component to be still in an accelerating state when just entering the panel area, resulting in ununiform coating of the initial part of the workpiece located in the panel area, affecting the product quality and reducing the productivity.

In the embodiment of the present disclosure, the coating device 110 comprises a primary machine 10 and a secondary machine 20, wherein the bearing surface of the secondary machine 20 is arranged in the initial coating region 70 to bear and receive the coating glue of this ununiform coated part, the bearing surface of the primary machine 10 is located in the uniform coating region and adjacent to the secondary machine 20, and the workpiece 60 to be coated is arranged on the primary machine 10. During the coating process of the coating device 110, the coating component 62 firstly completes the acceleration process in the initial coating region 70 where the secondary machine 20 is located, reaches a uniform speed, and then reaches above the workpiece 60 on the primary machine 10, thus realizing uniform coating of the workpiece 60.

The coating device 110 according to the embodiment of the present disclosure comprises the secondary machine 20 for assisting in coating, and the bearing surface thereof is arranged in the initial coating region 70, so that the coating component 62 can reach a uniform speed when reaching the workpiece 60 on the primary machine 10, thereby fundamentally eliminating the problem of poor initial part of the coating device 110, greatly reducing the times of line stopping maintenance, not only saving the labor cost, but also saving the cost of consumables such as clean cloth, rubber gloves and the like used for maintenance, improving the productivity and product quality, reducing the breakage of the workpiece 60 and avoiding quality accidents.

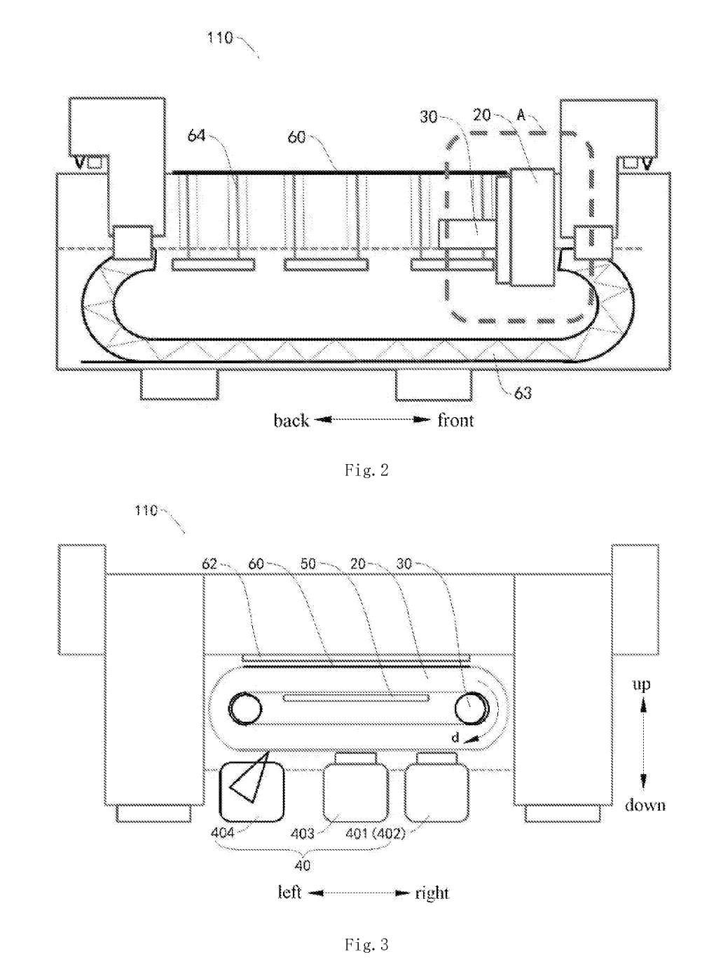

According to some embodiments of the present disclosure, the secondary machine 20 may be formed as a turntable or a conveyor belt which can rotate around a rotation axis extending in the horizontal direction. Here, the horizontal direction can be understood as a direction perpendicular to the vertical direction. For example, as shown in FIGS. 2 and 3, the vertical direction is the up-down direction, and the rotation axis of the turntable can extend in the front-back direction as shown in FIG. 2. When the secondary machine 20 rotates, the conveying direction of the bearing surface 201 of the secondary machine 20 is perpendicular to the coating direction b of the coating component 62. Thus, as the turntable rotates around the rotation axis, the bearing surface 201 of the secondary machine can rotate. The clean bearing surface 201 of the secondary machine can rotate to the initial coating region 70, while the bearing surface 201 of the secondary machine with the coating glue thereon can leave the initial coating region 70, which is convenient for cleaning the bearing surface 201 of the secondary machine with the coating glue thereon. According to the coating period of the coating component 62, the rotating speed of the turntable can be adjusted. The shorter the coating period of the coating component 62, the higher the rotating speed of the turntable. In addition, the width of the bearing surface 201 of the turntable extending along the axial direction of the rotation axis can also be adjusted according to the situation. It is only necessary to ensure that the ununiform glue coated by the coating component 62 in the initial coating stage can be borne or received by the bearing surface 201 of the turntable. In other words, the width of the outer peripheral surface of the turntable cannot be less than the width of the initial coating region of the coating device 110, that is, at least a part of the outer peripheral surface of the turntable forms the bearing surface of the secondary machine.

In certain exemplary embodiments, the secondary machine 20 can be movable relative to the primary machine 10, thereby making it easier to adjust the relative position between the primary machine 10 and the secondary machine 20. Adjusting the relative position between the primary machine 10 and the secondary machine 20 according to the size of the workpiece 60 to be coated can adapt to more production requirements. For example, as shown in FIG. 2, the moving direction of the secondary machine 20 relative to the primary machine 10 is parallel to the axial direction of the rotation axis of the secondary machine 20. In addition, the secondary machine 20 can extend and retract with respect to the primary machine 10. Before the primary machine 10 receives the workpiece 60 to be coated, the secondary machine 20 extends outward, and the distance between the primary machine 10 and the secondary machine 20 is increased. After the workpiece 60 to be coated is placed, the distance between the primary machine 10 and the secondary machine 20 is reduced, the secondary machine 20 retracts and is seamlessly connected with the workpiece 60 to be coated, thus realizing the fixation of the workpiece 60 to be coated. After the coating is completed, the secondary machine 20 extends outward again, releasing the coated workpiece, completing a cycle. The secondary machine 20 is movable and retractable relative to the primary machine 10, which facilitates the placement of the workpiece 60 to be coated and prevents the direct placement of the workpiece 60 causing the workpiece 60 to be broken.

According to some embodiments of the present disclosure, the bearing surface 201 of the secondary machine can be used to bear the coating glue fell thereon. As shown in FIG. 3, the secondary machine 20 can also include a cleaning mechanism 40 which can be used to clean the bearing surface 201 of the secondary machine 20. As the secondary machine 20 is arranged in the initial coating region 70, coating glue such as photoresist can be coated on the bearing surface 201 of the secondary machine 20 during accelerating coating process, which needs to be cleaned to facilitate sustainable use. The cleaning mechanism 40 can automatically clean up, so that the secondary machine 20 has its own cleaning function, which eliminates the need for manual cleaning, is more convenient and faster, has higher efficiency, and saves labor cost.

In some embodiments of the present disclosure, as shown in FIG. 3, the cleaning mechanism 40 may include a liquid spraying unit 401 and a scraping unit 402, wherein the liquid spraying unit 401 and the scraping unit 402 are integrally provided. The liquid spraying unit 401 can spray diluent to the bearing surface 201 of the secondary machine, and the scraping unit 402 can clean the bearing surface 201 of the secondary machine by scraping. The scraping unit 402 can scrape while diluent is being sprayed by the liquid spraying unit 401. This integrated arrangement makes the structure of the secondary machine 20 of the coating device 110 simpler and saves space.

The present disclosure does not particularly limit the specific structures and materials of the liquid spraying unit 401 and the scraping unit 402. For example, according to some examples of the present disclosure, the liquid spraying unit 401 may be a nozzle in which diluent is contained. The scraping unit 402 can be a scraper or a scraper blade. The scraping unit 402 can be a rubber part, a plastic part or the like. These structures will not cause damage to the bearing surface 201 of the secondary machine and can ensure the cleaning effect.

It can be understood that the liquid spraying unit 401 and the scraping unit 402 are not limited to integrated setting, and the liquid spraying unit 401 and the scraping unit 402 can also be independently set according to actual needs. The scraping unit 402 is arranged on the downstream side of the liquid spraying unit 401 along the rotation direction of the turntable, and after the diluent dilutes the coating glue on the surface of the bearing surface 201 of the secondary machine, the scraping unit 402 cleans the diluted coating glue more easily by scraping.

Taking the embodiment shown in FIG. 3 as an example, the turntable rotates in a direction indicated by arrow d, the cleaning mechanism 40 is arranged below the turntable, the downstream side of the liquid spraying unit 401 in the rotation direction of the turntable refers to the left side of the liquid spraying unit 401, and the upstream side of the liquid spraying unit 401 in the rotation direction of the turntable refers to the right side of the liquid spraying unit 401.

Further, the cleaning mechanism 40 may also include a wiping unit 403, as shown in FIG. 3, which may be arranged on the downstream side of the scraping unit 402 along the rotation direction of the turntable and in contact with the bearing surface 201 of the secondary machine. The wiping unit 403 cleans the bearing surface 201 of the secondary machine by wiping. After cleaning by the liquid spraying unit 401 and the scraping unit 402, the residual diluent on the bearing surface 201 of the secondary machine is cleaned by the wiping unit 403, and the residual coating glue is further cleaned to make the cleaning more thorough.

In the embodiment of the present disclosure, the wiping unit 403 may be, but not limited to, soft materials such as dust-free cloth and dust-free paper which are not easy to damage the bearing surface 201 of the secondary machine and are beneficial to cleaning.

Further, as shown in FIG. 3, the cleaning mechanism 40 can also include a hot air unit 404 which can be used to further clean the bearing surface 201 of the secondary machine. The hot air unit 404 can be arranged on the downstream side of the wiping unit 403 along the rotation direction of the turntable. After the cleaning of the wiping unit 403, the hot air unit 404 cleans the bearing surface 201 of the secondary machine by blowing hot air, heats, dissolves and cleans the diluent film remaining on the bearing surface 201 of the secondary machine, and further cleans some particles attached to the bearing surface 201 of the secondary machine, thus ensuring more cleaner of the bearing surface 201 of the secondary machine.

According to some examples of the present disclosure, the hot air unit 404 may be a component capable of blowing hot air such as a blower, which is easy to regulate and control air temperature and air force and is simple and convenient to operate. Of course, the hot air unit 404 may be other devices that can eject hot air, and it is only necessary to meet the requirements of heating and dissolving the residual diluent film and cleaning it.

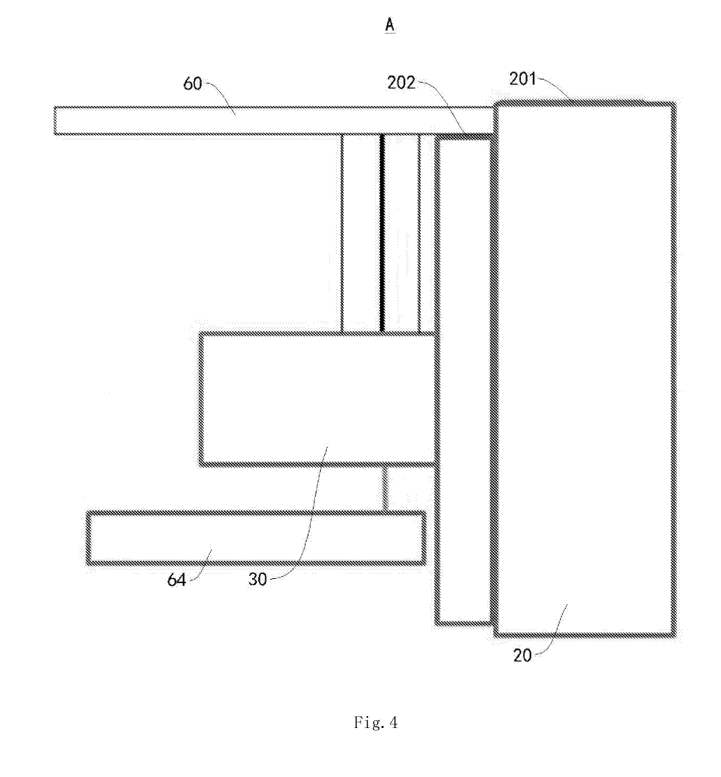

In some embodiments of the present disclosure, as shown in FIGS. 2 and 4, one end of the bearing surface 201 of the secondary machine adjacent to the primary machine 10 is provided with a recess 202, and the shape of the recess 202 is a step whose height is lower than that of the bearing surface of the secondary machine in the vertical direction. The height of the upper surface of the recess 202 is lower than the height of the upper surface of the workpiece 60 to be coated, and one end of the workpiece 60 to be coated close to the secondary machine 20 can be borne on the upper surface of the recess 202, so that the secondary machine 20 and the workpiece 60 to be coated are better matched and positioned, and the workpiece 60 to be coated is prevented from being clamped and deflected when placed, wherein clamping and deflecting may lead to the breakage of the workpiece 60. In addition, the coating glue coated on the bearing surface 201 of the secondary machine 20 has certain fluidity, and the recess 202 can prevent the coating glue from flowing to the primary machine 10 or even to the inside of the primary machine 10 along the bearing surface 201 of the secondary machine. It is easier to clean the coating device 110 by using the secondary machine 20 with its own cleaning mechanism 40, and it also ensures the safety and tidiness of the coating device 110.

Further, as shown in FIGS. 2 and 4, the vertical cross-section of the recess 202 can be formed into a rectangle, and here, the vertical cross-section of the recess 202 refers to a cross-section taken through a vertical plane parallel to the axial direction of the rotation axis of the secondary machine 20. The upper surface of the rectangle is flush with the upper surface of the workpiece 60 to be coated such as a glass substrate, and the outer side surface of the rectangle can abut against one end face of workpiece 60 to be coated, so that the recess 202 is better matched with workpiece 60 to be coated. Furthermore, the rectangular structure is easy to manufacture, which can simplify the production process.

It is to be understood that the recess 202 described above is formed into a rectangle which is described by way of example only, and the recess 202 can also be formed into other shapes, which is understandable to those skilled in the art and will not be described in detail here.

According to a further embodiment of the present disclosure, the secondary machine 20 may also include a secondary machine driving portion 30. In some examples of the present disclosure, the secondary machine driving portion 30 may be, but not limited to, a device that can provide driving force for cylinders, motors and the like. The secondary machine driving portion 30 can drive the secondary machine 20 to rotate, can be mechanically controlled and has better driving performance. Of course, the secondary machine driving portion 30 can also drive the secondary machine 20 to move or retract relative to the primary machine 10, which facilitates the taking and placing of the workpiece 60. In addition, according to the actual situation of the accumulated amount of coating glue on the bearing surface 201 of the secondary machine 20, the rotation speed of the secondary machine 20 can be set to avoid continuous idling caused by too fast rotation speed, thus avoiding unnecessary energy consumption or incomplete cleaning caused by too fast rotation speed. At the same time, it is ensured that the coating glue will not flow to the primary machine 10, and the cleaning is timely.

It should be noted that according to actual needs, the secondary machine driving portion 30 can control the rotation of the secondary machine 20 or the movement or retraction of the secondary machine 20 relative to the primary machine 10 in a variety of settings. For example, the secondary machine driving portion 30 can control the rotation of the secondary machine 20 and the movement or retraction of the secondary machine 20 relative to the primary machine 10 at the same time, so as to realize the renewal (cleaning) of the bearing surface 201 of the secondary machine and the replacement of the workpiece 60 at the same time. For example, the secondary machine driving portion 30 can also control the secondary machine 20 to rotate at first to renew the bearing surface 201 of the secondary machine, and then the secondary machine driving portion 30 can control the secondary machine 20 to move or retract relative to the primary machine 10 to realize the replacement of the workpiece 60.

According to some embodiments of the present disclosure, the shape of the turntable in the longitudinal cross section perpendicular to its rotation axis is elliptical, as shown in FIG. 3. Specifically, the turntable with elliptical cross section has long sides and short sides, and the long sides extend in the left-right direction. The liquid spraying unit 401, the wiping unit 403 and the hot air unit 404 can be arranged below the turntable in sequence along the rotation direction of the turntable, so that the bearing surface 201 of the outer peripheral surface of the turntable rotates away from the initial coating region 70, and then is cleaned by the liquid spraying unit 401, the wiping unit 403 and the hot air unit 404 in sequence, thus realizing thorough cleaning of the bearing surface 201 of the secondary machine. The long side of the upper end of the elliptical outer peripheral surface is located in the initial coating region 70, which has a large effective working area. is better to fix the workpiece 60 to be coated and can better prevent the coating glue in the initial coating region 70 from overflowing. A cleaning mechanism 40 is arranged below the long side of the lower end of the elliptical outer peripheral surface, which makes cleaning more convenient. The left and right sides of the elliptical outer peripheral surface are formed into semicircular shapes, which reduces the distance between the upper and lower long sides of the elliptical shape, thus saving the space of the turntable and making the structural design of the turntable more reasonable.

The secondary machine 20 according to some embodiments of the present disclosure may also include a heating unit 50, which may heat the bearing surface 201 of the secondary machine as shown in FIG. 3. As the bearing surface 201 of the secondary machine 20 is cyclically used, trace diluent may remain on the surface of the bearing surface 201 of the secondary machine. However, the diluent is volatile organic solvent, the heating unit 50 can heat the bearing surface 201 of the secondary machine to remove the residual trace diluent, thus further ensuring the cleanness of the bearing surface 201 of the secondary machine. In addition, heating the bearing surface 201 of the secondary machine by the heating unit 50 can prevent the viscous glue from solidifying on the bearing surface 201 of the secondary machine and facilitate the removal of the coating glue

It should be noted that the present disclosure does not particularly limit the position of the heating unit 50, for example, the heating unit 50 can be arranged on the upstream side of the cleaning mechanism 40 along the rotation direction of the turntable and can prevent the coating glue on the bearing surface 201 of the secondary machine from solidifying. The heating unit 50 may also be provided on the downstream side of the cleaning mechanism 40 along the rotation direction of the turntable, and residual trace diluent can be further removed by volatilization. Alternatively, the heating unit 50 can be provided in the initial coating region 70, which can simultaneously prevent the coating glue from solidifying and remove residual diluent. For example, in the example shown in FIG. 3, the heating unit 50 may be provided on the lower side of the upper end long side of the elliptical outer peripheral surface of the turntable, that is, the heating unit 50 is adjacent to the bearing surface 201 located in the initial coating region 70 and provided on the back of the bearing surface 201 of the secondary machine, so that the whole secondary machine 20 is compact in structure.

Further, the heating temperature of the heating unit 50 can be 40° C.-60° C. On the one hand, it can ensure that the residual trace diluent is completely volatilized, on the other hand, it can prevent the coating glue on the bearing surface 201 of the secondary machine from solidifying due to high temperature, which is not easy to be removed. For example, in some specific embodiments of the present disclosure, the heating temperatures of the heating unit 50 may be 45° C. , 50° C. , 55° C. and the like, respectively.

Other components of the coating device 110 according to a specific embodiment of the present disclosure will be described below with reference to the accompanying drawings.

As shown in FIGS. 1-4, the coating device 110 further includes a gantry 61, permanent magnet guide rails 63 and lift pins 64. It also includes the coating component 62, the primary machine 10, the secondary machine 20 and the like which have been mentioned above. The bearing surface 201 of the secondary machine 20 is located in the initial coating region 70, the recess 202 is located in the uniform coating region, and the bearing surface of the primary machine 10 is completely located in the uniform coating region. In the coating process, at first, the workpiece 60 to be coated is placed on the panel area 101 on the primary machine 10 in a direction indicated by arrow a in FIG. 1, driven by the rotation of the permanent magnet guide rails 63, and one end of the workpiece 60 to be coated near the initial coating region 70 is placed on the recess 202 of the secondary machine 20 and is fixed thereon. Subsequently, the coating component 62 is accelerated in the initial coating region 70 in the coating direction indicated by arrow b under the drive of the gantry 61, and the coating glue is continuously sprayed and falls on the surface of the bearing surface 201 of the secondary machine. When the coating component 62 reaches a predetermined speed, the coating component 62 enters the uniform coating region at a constant speed, and the coating component 60 performs coating. After the coating, the workpiece 60 is jacked up by the lift pins 64, thereby releasing the fixation. Driven by the permanent magnet guide rails 63, the workpiece 60 leaves the panel area 101 in a direction indicated by arrow c. The secondary machine 20 rotates in a direction indicated by arrow d in FIG. 3, and the bearing surface 201 of the secondary machine with coating glue thereon rotates above the cleaning mechanism 40 for cleaning. The cleaning mechanism 40 is sequentially provided with the liquid spraying unit 401, the scraping unit 402, the wiping unit 403 and the hot air unit 404 along the rotation direction of the secondary machine 20, wherein, the liquid spraying unit 401 and the scraping unit 402 are integrally arranged.

The coating device 110 according to the embodiment of the present disclosure can achieve a uniform speed before the coating component 62 coats the workpiece 60 to be coated, fundamentally eliminating the problem of poor initial part of the coating device 110, reducing maintenance times, improving productivity and product quality, reducing the breakage of the workpiece 60 and avoiding quality accidents.

Other configurations and operations of the coating device 110 according to the embodiments of the present disclosure are known to those of ordinary skill in the art and will not be described in detail here.

In the description of this disclosure, it should be noted that unless otherwise specified and limited, the terms “installation”, “connecting” and “connection” should be broadly understood, for example, they can be fixed connection, detachable connection or integrated connection, or can be a mechanical connection or an electrical connection; it can also be directly connected or indirectly connected through intermediate media, and it can be communication between the insides of two elements. For those of ordinary skill in the art, the specific meanings of the above terms in this disclosure can be understood in specific situations.

In the description of this specification, reference to the descriptions of the terms “embodiment”, “specific embodiment”, “example” and the like means that a specific feature, structure, material or characteristic described in connection with this embodiment or example is included in at least an embodiment or example of this disclosure. In this specification, the schematic expression of the above terms does not necessarily refer to the same embodiment or example. Moreover, the specific features, structures, materials or characteristics described can be combined with each other in a suitable way without interference or contradiction in any one or more embodiments or examples.

1. A coating device comprising:
a coating component for coating a workpiece to be coated, wherein the coating component has an accelerated motion stage and a uniform motion stage during a running process, wherein an initial coating region of the coating device corresponds to the accelerated motion stage, and a uniform coating region of the coating device corresponds to the uniform motion stage;
a primary machine used for bearing the workpiece to be coated, wherein a bearing surface of the primary machine is located in the uniform coating region of the coating device; and
a secondary machine for assisting in coating, wherein a bearing surface of the secondary machine is located in the initial coating region of the coating device.

2. The coating device according to claim 1, wherein the secondary machine comprises a turntable which can rotate around a rotation axis extending in a horizontal direction, and wherein at least a part of an outer peripheral surface of the turntable forms the bearing surface of the secondary machine.

3. The coating device according to claim 1, wherein the secondary machine is movable relative to the primary machine.

4. The coating device according to claim 2, wherein the secondary machine further comprises a cleaning mechanism for cleaning the bearing surface of the secondary machine.

5. The coating device according to claim 4, wherein the cleaning mechanism comprises:
a liquid spraying unit for spraying diluent on the bearing surface of the secondary machine;
a scraping unit for cleaning the bearing surface of the secondary machine by scraping, wherein the scraping unit is arranged on a downstream side of the liquid spraying unit along a rotating direction of the turntable or is integrated with the liquid spraying unit.

6. The coating device according to claim 5, wherein the cleaning mechanism further comprises a wiping unit arranged on a downstream side of the scraping unit along the rotation direction of the turntable and in contact with the bearing surface of the secondary machine, wherein the wiping unit can further clean the bearing surface of the secondary machine by wiping.

7. The coating device according to claim 6, wherein the cleaning mechanism further comprises a hot air unit for cleaning the bearing surface of the secondary machine, wherein the hot air unit is arranged on a downstream side of the wiping unit along the rotating direction of the turntable, wherein the hot air unit can further clean the bearing surface by blowing air.

8. The coating device according to claim 1, wherein one end of the bearing surface of the secondary machine is provided with a recess.

9. The coating device according to claim 8, wherein a vertical cross section of the recess is a rectangle.

10. The coating device according to claim 2, wherein the secondary machine further comprises a secondary machine driving portion for driving the secondary machine to rotate and/or move relative to the primary machine.

11. The coating device according to claim 7, wherein a longitudinal cross section of the turntable perpendicular to its rotation axis is an ellipse, and the liquid spraying unit, the wiping unit and the hot air unit are sequentially arranged below the turntable along the rotation direction of the turntable.

12. The coating device according to claim 1, wherein the secondary machine further comprises a heating unit for heating the bearing surface of the secondary machine.

13. The coating device according to claim 12, wherein a heating temperature of the heating unit is 40° C. to 60° C.

14. The coating device according to claim 10, wherein a movement direction of the secondary machine relative to the primary machine is parallel to an axial direction of the rotation axis of the secondary machine.

15. The coating device according to claim 10, wherein when the secondary machine rotates, a conveying direction of the bearing surface of the secondary machine is perpendicular to a coating direction of the coating component.

16. The coating device according to claim 15, wherein the coating direction of the coating component is parallel to an axial direction of the rotation axis of the secondary machine.

17. The coating device according to claim 9, wherein one end of the workpiece to be coated near the secondary machine is borne on an upper surface of the recess.

18. The coating device according to claim 2, wherein a width of the bearing surface of the secondary machine, extending in a direction parallel to an axial direction of the rotation axis, is about 5 cm.
